(19) United States
(12) Patent Application Publication
(10) Pub. No.: US 2011/0254561 A1
(43) Pub. Date: Oct. 20, 2011

(54) DEVICE FOR SYNCHRONIZED CELL VOLTAGE MEASUREMENT IN A PLURALITY OF ELECTRICAL STORAGE CELLS

(76) Inventor: Stefan Butzmann, Beilstein (DE)

(21) Appl. No.: 12/998,699

(22) PCT Filed: Nov. 19, 2009
(86) PCT No.: PCT/EP2009/065484

§ 371 Date: Jul. 5, 2011

(30) Foreign Application Priority Data
Nov. 20, 2008 (DE) 10 2008 043 921.5

(51) Int. Cl. G01N 27/416

(52) U.S. Cl. 324/434

(57) ABSTRACT

The invention relates to a device for measuring the electrical cell voltages in several electrical storage cells of an electrical storage medium. Each storage cell has an associated measuring device and the measurement values of the measurement devices are read out based on a read command of a control unit. According to the invention, a synchronization line leading from the control unit to the measurement devices or from one of the measurement devices to all other measurement devices is provided for simultaneously reading out the measurement values. The invention further relates to a corresponding method.

The invention relates to a device for measuring the electrical cell voltages in a plurality of electrical storage cells of an electrical storage medium, in which each storage cell has an associated measuring device, and the measurement values of the measuring devices are read out on the basis of a read command of a control unit. The invention further pertains to a corresponding method.

### PRIOR ART

Devices of the aforementioned time are known. For stationary applications, such as wind farms, and in vehicles, such as in hybrid and electric vehicles, new electrical storage media are needed, of which very stringent demands are made in terms of their reliability. This is due to the fact that a failure of such storage media can lead to a failure of an entire system, such as an entire electric vehicle. In the example of the electric vehicle, a failure of a traction battery, that is, a storage medium which supplies the drive of the electric vehicle, can lead to a failure of the entire electric vehicle. Moreover, a failure of the storage medium can lead to safety-related problems. In the example of a wind farm, for instance, storage media are used for protecting the wind farm in high winds against impermissible operating states, by adjusting a rotor blade that the storage medium supplies with energy.

Electrical storage media of this type, to attain the requisite power and energy data, are produced from individual storage cells that are connected in series with one another. In part, it can be provided that a plurality of storage cells are additionally connected in parallel to one another. The series-connected storage cells have to be monitored during operation of the electrical storage medium with regard to their electrical cell voltages. To that end, measuring devices are used, which are operated in series to one another and in parallel with the storage cells. Typically, only a first measuring device communicates with a central control unit, while all the other measuring devices are connected to the respective preceding measuring device via a data BUS. If the electrical cell voltages of all the storage cells are to be measured, then the central control unit sends a read command to the first measuring device, which passes it on to the next measuring device. As a consequence, the read command arrives with a delay at the last measuring device for the read command. This delay is due to the individual transit time of the read command from one measuring device to the next successive measuring device, multiplied by the number of measuring devices. Because of this procedure, chronologically offset measurements of the individual cell voltages are the result.

The object of the invention is to enable simultaneous measurement of the electrical cell voltages at all the measuring devices.

### DISCLOSURE OF THE INVENTION

According to the invention, it is provided that for simultaneous readout of the measurement values, a synchronization line is provided, leading from the control unit to the measuring devices, or from one of the measuring devices to all the other measuring devices. The synchronization line makes it possible for all the measuring devices to be supplied simultaneously with a synchronization signal, which causes all the measuring devices to measure the cell voltages at the same time. Either the synchronization line, by the control unit itself, or one of the measuring devices, in particular the measuring device that is connected directly to the control unit, can be subjected to the synchronization signal. The advantage of a synchronization line that is connected to the control unit is the common control of the sending of the read command and the sending of the synchronization signal by the control unit. If the synchronization line is provided from one of the measuring devices to all the other measuring devices, the advantage is obtained that the control unit can be disposed in spaced-apart fashion from the measuring devices in a simple way. Moreover, the construction of the synchronization line is simplified.

In a refinement of the invention, it is provided that the synchronization line has at least one potential-free signal coupling device. The potential-free signal coupling device uncouples at least one measuring device from all the other measuring devices and from the control unit. This leads to an improvement in the outcomes of the measurement and to increased safety in the use of the measuring devices.

In a refinement of the invention, it is provided that the signal coupling device is an optocoupler, a magnetoresistive coupler, and/or a capacitive coupler. In the case of an optocoupler, the signal coupling device is connected to at least one measuring device via an optical connection, and it is simultaneously connected to another of the measuring devices or to the control unit via an electrical connection. The magnetoresistive coupler and the capacitive coupler are connected to the measuring devices electrically. They form two separate current circuits; one current circuit is connected to one measuring device, and the other current circuit is connected either to one of the other measuring devices or to the control unit. As a result, the signal coupling device implements the synchronization signal from the control unit or measuring device to the measuring devices.

In a refinement of the invention, it is provided that each measuring device is assigned one signal coupling device. In this especially advantageous refinement, the individual cell voltages are each detected by one measuring device. As a consequence, all the cell voltages can be detected simultaneously, especially accurately and quickly.

In a refinement of the invention, at least one latency waiting time device that takes a signal transit time of the read command into account is provided. The latency waiting time device generates a latency waiting time for sending the synchronization signal. The latency waiting time device preferably takes the sending of the read command as a starting time for the latency waiting time and enables the sending of the synchronization signal only after the latency waiting time has elapsed.

The invention further relates to a method for measuring the electrical cell voltages in a plurality of electrical storage cells of an electrical storage medium, in particular by means of the devices described above, in which each storage cell has an associated measuring device, and the measurement values of the measuring devices are read out on the basis of a read command of a control unit. It is provided that for the simultaneous readout of the measurement values, a synchronization signal is sent from the control unit to the measuring devices or from one of the measuring devices to all the other measuring devices. The synchronization signal is preferably sent via a synchronization line. It can be embodied for instance as a positive or negative electrical edge and in the measuring devices leads to the tripping of the readout of the measurement values. Thus the measuring devices first receive the read command, which not executed until in conjunction with the synchronization signal. As a consequence, despite the signal transit time of the read command, all the electrical cell voltages can be read out simultaneously.

In a refinement of the invention, it is provided that the synchronization signal is sent after the read command has been sent, and after an ensuing latency waiting time. In that case, the latency waiting time is waited out until the synchronization signal effects the actual readout of the electrical cell voltages. Thus the signal transit time of the read command can be taken into account.

In a refinement of the invention, it is provided that at least one maximum transit time of the read command, from when it is sent until it is received at all the associated measuring devices, is selected as the latency waiting time. The maximum transit time of the read command is the result of the maximum individual transit times of the read command between two measuring devices, multiplied by the number of all the measuring devices present.

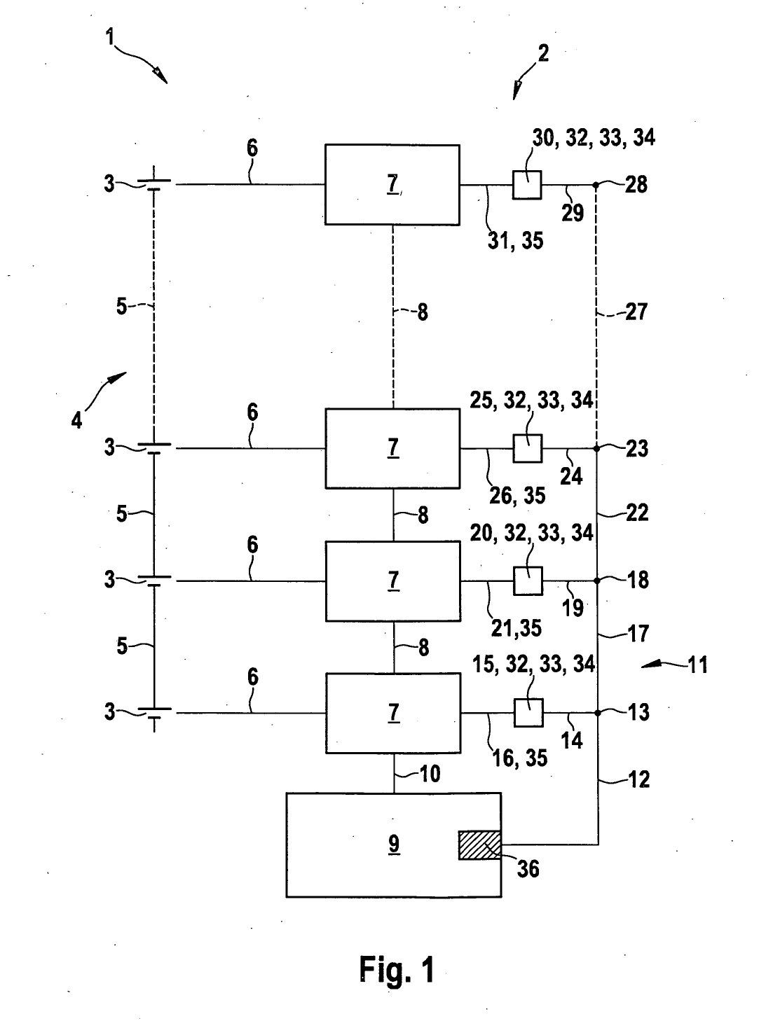

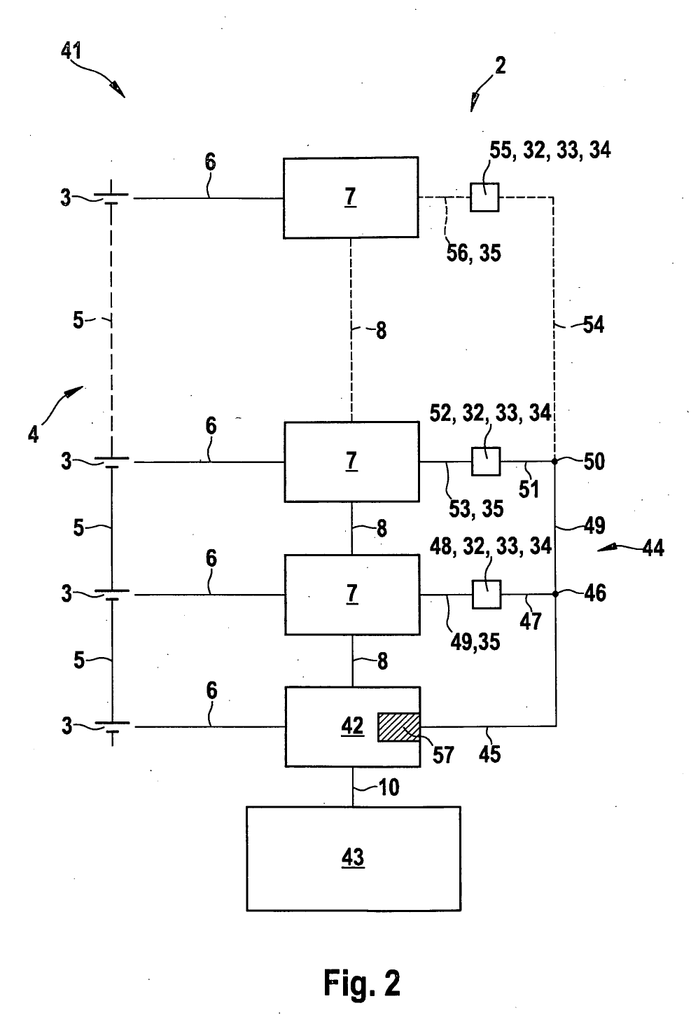

Below, the invention will be described in terms of exemplary embodiments. FIGS. 1 and 2 show two exemplary embodiments of the device of the invention; specifically:

FIG. 1 shows a first embodiment of the device of the invention; and

FIG. 2 shows a second embodiment of the device of the invention.

FIG. 1 shows a first embodiment 1 of the device 2 according to the invention for measuring electrical cell voltages in a plurality of electrical storage cells 3 of an electrical storage medium 4. The storage cells 3 are connected in series with one another by means of lines 5. Via measurement lines 6, the individual storage cells 3 are each connected to a respective measuring device 7 assigned to them. The measuring devices 7 in turn are connected in series, via respective BUS lines 8. The device 2 further has a control unit 9, which is connected by means of a BUS line 10 to one of the measuring devices 7. A synchronization line 11 also begins at the control unit 9 and leads to all the measuring devices 7. The synchronization line 11 has a first line 12, which leads from the control unit 9 to the first node point 13. From the node point 13, a line 14 leads to a potential-free signal coupling device 15, which is connected to one of the measuring devices 7 via a line 16. From the node point 13, a further line 17 leads to a node point 18. The node point 18 is connected via a line 19 to a further signal coupling device 20. The signal coupling device 20 is connected in turn to one of the measuring devices 7 via a line 21. From the node point 18, a line 22 leads to a node point 23. The node point 23 is connected via a line 24 to a further signal coupling device 25. The signal coupling device 25 is connected to one of the measuring devices 7 via a line 26. From the node point 23, a line 27 leads to a node point 28, which is connected via a line 29 to an additional signal coupling device 30. The signal coupling device 30 is connected via a line 31 to a further measuring device 7. The illustration in FIG. 1 is a fragmentary view of the device 2 of the invention and of the electrical storage medium 4. It can be continued logically into the regions indicated by dashes, that is, in the line 5 shown in dashes, the corresponding BUS line 8, and the corresponding lines 27. The signal coupling devices 15, 20, 25 and 30 can be embodied variously. Embodiments as an optocoupler 32, magnetoresistive coupler 33 and/or capacitive coupler 34 are conceivable. In the case of an embodiment as an optocoupler 32, the lines 16, 21, 26 and 31 are embodied as optical lines 35. Inside the control unit 9, a latency waiting time device 36 is provided, which cooperates with the synchronization line 11.

For measuring the electrical cell voltage of the storage cells 3, the control unit 9 sends a read command via the BUS line 10 to the measuring device 7 that is connected to the BUS line 10. The measuring device 7 in turn sends the read command onward via the BUS line 8. All the measuring devices 7 proceed in this way, as long as they have a neighboring measuring device 7 which is to be supplied with the read command. Inside each measuring device 7, the read command is recorded, but no readout of the measurement values is done. Inside the control unit 9, the time when the read command is sent out to the BUS line 10 is recorded by the latency waiting time device 36, and a latency waiting time is waited out. After the latency waiting time, the latency waiting time device 36 outputs a synchronization signal into the synchronization line 11. The synchronization signal then proceeds initially over the line 12 to the signal coupling devices 15, 20, 25 and 30. They implement the synchronization signal in such a way as to allow the measuring devices 7 of the control unit 9 not to be connected directly to one another electrically. The signal coupling devices 15, 20, 25 and 30 next output the synchronization signal to the various measuring devices 7 via the lines 16, 21, 26 and 31. The synchronization signal is effected in the form of a signal edge and acts in the measuring devices 7 as tripping means for the readout of the measurement values. The measurement values are detected by the storage cells 3 via the measurement lines 6. Finally, all the measurement values detected can be returned to the control unit 9 via the BUS lines 8 and 10. In order to adjust the latency waiting time correctly, it is provided that the latency waiting time can be selected manually in the latency waiting time device 36. In particular, it is provided that a maximum transit time of the read command from the control unit 9 to the last measuring device 7, or in other words the last measuring device 7 in the travel direction of the read command, is used. In that case, it is ensured that when the synchronization signal is sent out, all the measuring devices 7 will have already received the read command. Proceeding in this way ensures that all the cell voltages can be detected at the same time.

FIG. 2 shows a second embodiment 41 of the device 2 according to the invention for measuring electrical cell voltages in a plurality of electrical storage cells 3 of the electrical storage medium 4. The storage cells 3 are connected in series with one another by means of lines 5. Via the measurement lines 6, the individual storage cells 3 are each connected to the respective measuring device 7 and 42 assigned to them. The measuring devices 7 and 42 are in turn connected in series via a respective BUS line 8. The device 2 further has a control unit 43, which in turn is connected by means of a BUS line 10 to the measuring device 42. A synchronization line 44 begins at the measuring device 42 and leads to all the measuring devices 7. The synchronization line 44 has a first line 45, which leads from the control unit 43 to a first node point 46. From the node point 46, a line 47 leads to a potential-free signal coupling device 48, which is connected via a line 49 to one of the measuring devices 7. From the node point 46, a further line 49 leads to a node point 50. The node point 50 is connected via a line 51 to a further signal coupling device 52. The signal coupling device 52 is in turn connected to one of the measuring devices 7, via a line 53. From the node point 50, a line 54 leads to a further signal coupling device 55. The signal coupling device 55 is connected to one of the measuring devices 7 via a line 56. The illustration in FIG. 2 is a fragmentary view of the device 2 of the invention and of the electrical storage medium 4. It can logically be extended into the regions shown in dashed lines, that is, in the line 5 shown in dashed lines, the corresponding BUS line 8, and the associated lines 54. The signal coupling devices 48, 52 and 56 can be variously embodied. Embodiments as an optocoupler 32, magnetoresistive coupler 33 and/or capacitive coupler 34 are conceivable. In the case of an embodiment as an optocoupler 32, the lines 49, 53 and 56 are embodied as optical lines 35. Inside the measuring device 42, a latency waiting time device 57 is provided, which cooperates with the synchronization line 44.

For measuring the electrical cell voltage of the storage cells 3, the control unit 43 sends a read command via the BUS line 10 to the measuring device 42 that is connected to the BUS line 10. The measuring device 42 in turn sends the read command onward via the BUS line 8. All the measuring devices 7 proceed in this way, as long as they have a neighboring measuring device 7 which is to be supplied with the read command. Inside the measuring devices 7 and 42, the read command is recorded, but no readout of the measurement values is done. Inside the measuring device 42, the sending of the read command to the BUS line 10 is recorded by the latency waiting time device 57, and a latency waiting time is waited out. After the latency waiting time, the latency waiting time device 57 outputs a synchronization signal into the synchronization line 44. The synchronization signal then proceeds initially over the line 45 to the signal coupling devices 48, 52 and 55. They implement the synchronization signal in such a way as to allow the measuring devices 7 of the measuring device 42 not to be connected directly to one another electrically. The signal coupling devices 49, 53 and 55 next output the synchronization signal to the various measuring devices 7 via the lines 49, 53 and 56. The synchronization signal is effected in the form of a signal edge and acts in the measuring devices 7 and 42 as tripping means for the readout of the measurement values. The measurement values are detected by the storage cells 3 via the measurement lines 6. Finally, all the measurement values detected can be returned to the control unit 43 via the BUS lines 8 and 10. In order to adjust the latency waiting time correctly, it is provided that the latency waiting time can be selected manually in the latency waiting time device 57. In particular, it is provided that a maximum transit time of the read command from the control unit 43 to the last measuring device 7, or in other words the last measuring device 7 in the travel direction of the read command, is used. In that case, it is ensured that when the synchronization signal is sent out, all the measuring devices 7 and 42 will have already received the read command. Proceeding in this way ensures that all the cell voltages can be detected at the same time.

1-8. (canceled)

9. A device for measuring the electrical cell voltages in a plurality of electrical storage cells of an electrical storage medium, in which
each storage cell has an associated measuring device, and measurement values of the measuring devices are read out based on a read command of a control unit, and for simultaneous read out of the measurement values, a synchronization line is provided, leading from the control unit to the measuring devices or from one of the measuring devices to all other measuring devices.

10. The device as defined by claim 9, wherein the synchronization line has at least one potential-free signal coupling device.

11. The device as defined by claim 10, wherein the signal coupling device is an optocoupler, a magnetoresistive coupler, and/or a capacitive coupler.

12. The device as defined by claim 9, wherein each measuring device is assigned one signal coupling device.

13. The device as defined by claim 10, wherein each measuring device is assigned one signal coupling device.

14. The device as defined by claim 11, wherein each measuring device is assigned one signal coupling device.

15. The device as defined by claim 9, wherein at least one latency waiting time device takes a signal transit time of the read command into account.

16. The device as defined by claim 10, wherein at least one latency waiting time device takes a signal transit time of the read command into account.

17. The device as defined by claim 11, wherein at least one latency waiting time device takes a signal transit time of the read command into account.

18. The device as defined by claim 12, wherein at least one latency waiting time device takes a signal transit time of the read command into account.

19. The device as defined by claim 13, wherein at least one latency waiting time device takes a signal transit time of the read command into account.

20. The device as defined by claim 14, wherein at least one latency waiting time device takes a signal transit time of the read command into account.

21. A method for measuring the electrical cell voltages in a plurality of electrical storage cells of an electrical storage medium, in particular with a device as defined by claim 9, comprising the steps of:
associating a measuring device with each storage cell;
reading out measurement values of the measuring devices based on a read command of a control unit; and
for simultaneous read out of the measurement values, sending a synchronization signal from the control unit to the measuring devices or from one of the measuring devices to all the other measuring devices.

22. A method for measuring the electrical cell voltages in a plurality of electrical storage cells of an electrical storage medium, in particular with a device as defined by claim 10, comprising the steps of:
associating a measuring device with each storage cell;
reading out measurement values of the measuring devices based on a read command of a control unit; and
for simultaneous read out of the measurement values, sending a synchronization signal from the control unit to the measuring devices or from one of the measuring devices to all the other measuring devices.

23. A method for measuring the electrical cell voltages in a plurality of electrical storage cells of an electrical storage medium, in particular with a device as defined by claim 11, comprising the steps of:
associating a measuring device with each storage cell;
reading out measurement values of the measuring devices based on a read command of a control unit; and
for simultaneous read out of the measurement values, sending a synchronization signal from the control unit to the measuring devices or from one of the measuring devices to all the other measuring devices.

24. A method for measuring the electrical cell voltages in a plurality of electrical storage cells of an electrical storage medium, in particular with a device as defined by claim 12, comprising the steps of:
associating a measuring device with each storage cell;
reading out measurement values of the measuring devices based on a read command of a control unit; and
for simultaneous read out of the measurement values, sending a synchronization signal from the control unit to the measuring devices or from one of the measuring devices to all the other measuring devices.

25. A method for measuring the electrical cell voltages in a plurality of electrical storage cells of an electrical storage medium, in particular with a device as defined by claim 15, comprising the steps of:
associating a measuring device with each storage cell;
reading out measurement values of the measuring devices based on a read command of a control unit; and
for simultaneous read out of the measurement values, sending a synchronization signal from the control unit to the measuring devices or from one of the measuring devices to all the other measuring devices.

26. A method for measuring the electrical cell voltages in a plurality of electrical storage cells of an electrical storage medium, in particular with a device as defined by claim 20, comprising the steps of:
associating a measuring device with each storage cell;
reading out measurement values of the measuring devices based on a read command of a control unit; and
for simultaneous read out of the measurement values, sending a synchronization signal from the control unit to the measuring devices or from one of the measuring devices to all the other measuring devices.

27. The method as defined by claim 21, wherein the synchronization signal is sent after the read command is sent and after an ensuing latency waiting time.

28. The method as defined by claim 27, wherein as the latency waiting time, at least one maximum transit time, from being sent until being received at all the associated measuring devices, is selected.
